(19) United States
(12) Patent Application Publication
(10) Pub. No.: US 2021/0318420 A1
(43) Pub. Date: Oct. 14, 2021

(54) ULTRASONIC SENSORS FOR WORK MACHINE OBSTACLE DETECTION

(71) Applicant: Caterpillar Paving Products Inc., Brooklyn Park, MN (US)

(72) Inventors: Todd A. Impola, Minnetonka, MN (US); Timothy M. O'Donnell, Long Lake, MN (US)

(73) Assignee: Caterpillar Paving Products Inc., Brooklyn Park, MN (US)

(21) Appl. No.: 16/846,009

(22) Filed: Apr. 10, 2020

(51) Int. Cl. G01S 7/521; G01S 15/88

(52) U.S. Cl. CPC G01S 7/521; G01S 15/88

(57) ABSTRACT

A work machine includes a frame, a blade, a sensor assembly, and an ultrasonic sensor. The frame includes a first portion and a second portion configured to pivot with respect to the first portion for steering the work machine. The blade is attached to the second portion of the frame. The sensor assembly is positioned on the work machine and configured to sense data for detection of obstacles within a first area around the work machine. The ultrasonic sensor is attached to the second portion of the frame and is configured to sense data for detection of obstacles within a second area around the work machine, the second area outside the first area when the second portion is in an articulated position with respect to the first portion.

### TECHNICAL FIELD

The present application relates generally to work machines. More particularly, the present application relates to object detection using ultrasonic sensors for work machines.

### BACKGROUND

Work machines, such as compactor machines, can be used for compacting substrates. More particularly, after application of an asphalt layer on a. ground surface, a. compactor machine can be moved over the ground surface in order to achieve a planar ground surface, compactor machines can be manual, autonomous, or semi-autonomous. To aid in control of the compactor machine, obstacle detection may be employed to detect obstacles with respect to the compactor machine. European Patent No. 1.508819 B1 discloses a driving assistance system for an automobile that employs various types of sensors.

### SUMMARY OF THE INVENTION

In one example, a work machine includes a frame, a blade, a sensor assembly, and an ultrasonic sensor. The frame includes a first portion and a second portion configured to pivot with respect to the first portion for steering the work machine. The blade is attached to the second portion. The sensor assembly is positioned on the work machine and is configured to sense data for detection of obstacles within a first area around the work machine. The ultrasonic sensor is attached to the second portion and is configured to sense data for detection of obstacles within a second area around the work machine, the second area outside the first area when the second portion is in an articulated position with respect to the first portion.

In another example, a method for detecting obstacles during operation of a work machine includes sensing, using a first sensor assembly positioned on the work machine, data for detection of obstacles within a first area around the work machine; steering the work machine in a first direction by pivoting a second portion of a frame of the work machine with respect to a first portion of the frame of the work machine, wherein a blade is attached to the second portion of the frame; and sensing, using an ultrasonic sensor attached to the second portion of the frame, data for detection of obstacles within a second area around the work machine, the second area outside the first area when the second portion is in an articulated position with respect to the first portion.

In another example, a compactor includes first and second frame portions, a blade, a sensor assembly, and an ultrasonic sensor. The second frame portion is configured to articulate with respect to the first frame portion for steering the compactor. The blade is attached to the second frame portion. The sensor assembly is positioned on the first or the second frame portion and is configured to sense data for detection of obstacles within a first area around the compactor. The ultrasonic sensor is attached to the second frame portion and configured to sense data for detection of obstacles within a second area around the compactor, the second area outside the first area when the second frame portion is in an articulated position with respect to the first frame portion.

### BRIEF DESCRIPTION OF THE DRAWINGS

FIG. 1 is a diagram illustrating an articulated-type work machine that includes ultrasonic sensors for obstacle detection.

FIG. 2 is a front view of a portion of a work machine that includes ultrasonic sensors mounted to an attachment of the work machine.

FIG. 3 is a flowchart illustrating a method for obstacle detection during steering of a work machine using ultrasonic sensors.

### DETAILED DESCRIPTION

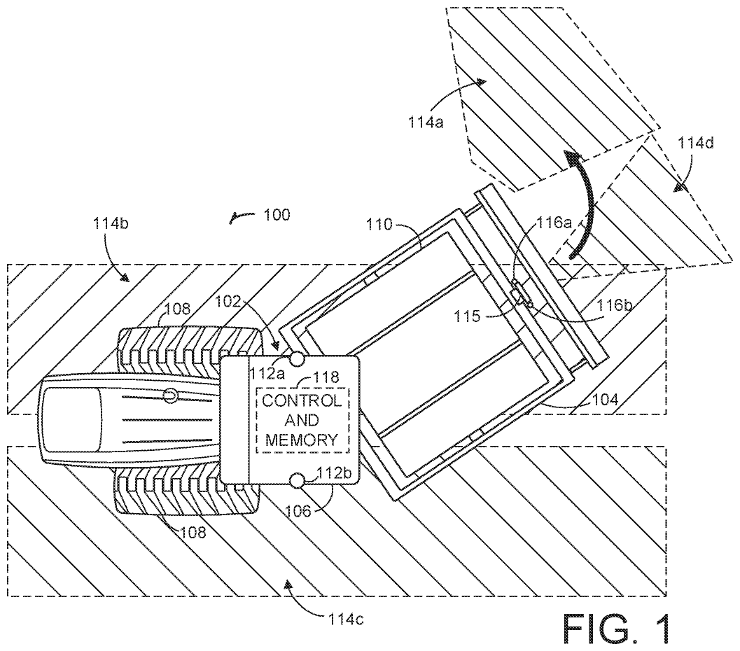

FIG. 1 is an overhead view illustrating an example compactor 100. While illustrated as a soil compactor, the systems and methods disclosed herein can be applied to any work machine including dozers, mixers, scrapers, motor graders, excavators, material haulers, and the like. The compactor 100 is adapted to move over a ground surface made of soil, asphalt, gravel, or any other surface, in order to compact it. The compactor 100 may be a manual, autonomous, or semi-autonomous machine, for example.

The compactor 100 includes a first frame 102, a second frame 104, an operator cab 106, wheels 108, and a compactor drum 110. The compactor drum 110 includes an outer surface that contacts the ground. An engine can be mounted on the compactor 100 for providing propulsion power. The engine may be an internal combustion engine such as a compression ignition diesel engine, or any other engine, including a gas turbine engine, for example. The operator cab 106 is mounted to the first frame 102. For manual or semi-autonomous machines, an operator of the compactor 100 can be seated within the operator cab 106 to perform one or more machine operations.

The second frame 104 may be connected to the first frame 102 such that the second frame 104 is able to articulate or pivot with respect to the first frame 102 to steer the compactor 100. The second frame 104 is configured to rotatably support the compactor drum 110, which moves along, and provides compaction for, the ground surface. The compactor drum 110 acts as a ground engaging member that rotates about a respective axis thereby propelling the compactor 100 on the ground surface along with the wheels 108. In other examples, the wheels 108 can be replaced with a second compactor drum that operates in a similar manner to the compactor drum 110.

The compactor 100 may include an obstacle detection system, for example, using one or more sensors or other devices configured to sense data for detection of obstacles around the compactor 100. For example, the compactor 100 may include two lidar assemblies 112a and 112b mounted to the first frame 102 and positioned to detect objects surrounding the compactor 100. Due to the field-of-view of the lidar assemblies 112a and 112b, two additional lidar assemblies may be needed to provide coverage for the area 114a when the frame 104 is articulated to steer the compactor 100 to the left (as illustrated by the arrow in FIG. 1), and a corresponding area when the second frame 104 is articulated to steer the compactor 100 to the right. For example, the position of the two lidar assemblies 112a and 112b on the first frame 102 can provide coverage for the front, rear and sides of the compactor 100, as illustrated by areas 114b and 114c. However, these two lidar assemblies 112a and 112b do not move with the articulated second frame 104, so the area 114a that is in a projected path of the compactor 100 during a left turn may not be detectable by the lidar assemblies 112a and 112b. Adding additional lidar assemblies to detect objects in the area 114a may be costly.

The obstacle detection system may also include a radar sensor 115. The radar sensor 115 may be mounted to the second frame 104 to provide further data regarding obstacles in front of the frame 104 of the compactor 100. For example, the radar sensor 115 may be able to provide coverage in front of the frame 104, as illustrated by area 114d. However, similar to the lidar assemblies 112a and 112b, the radar sensor 115 is unable to detect objects in the area 114a during a left turn.

To detect objects within the area 114a (and a corresponding area when the second frame 104 is articulated to turn the compactor 100 to the right), ultrasonic sensors 116a and 116b may be positioned on the front of the second frame 104. For example, due to the range provided by ultrasonic sensors, it may be desirable to position the ultrasonic sensors 116a and 116b on the front of the second frame 104, in front of the compactor drum 110. The placement of the ultrasonic sensors 116a and 116b on the second frame 104 provides steering coverage for the area 114a, eliminating the need for two additional lidar assemblies, providing a significant cost savings.

The compactor 100 may include a control and memory circuit 118 used to receive data from the lidar assemblies 112a and 112b, the radar sensor 115, the ultrasonic sensors 116a and 116b, and/or other sensors of an obstacle detection system. The control and memory circuit 118 can include, for example, software, hardware, and combinations of hardware and software configured to execute several functions related to, among others, obstacle detection for the compactor 100. The control and memory circuit 118 can be an analog, digital, or combination analog and digital controller including a number of components. As examples, the control and memory circuit 118 can include integrated circuit boards or ICB(s), printed circuit boards PCB(s), processor(s), data storage devices, switches, relays, or any other components. Examples of processors can include any one or more of a microprocessor, a controller, a digital signal processor (DSP), an application specific integrated circuit (ASIC), a field-programmable gate array (FPGA), or equivalent discrete or integrated logic circuitry.

The control and memory circuit 118 may include storage media to store and/or retrieve data or other information such as, for example, input data from the lidar assemblies 112a and 112b and the ultrasonic sensors 116a and 116b. Storage devices, in some examples, are described as a computer-readable storage medium, The data storage devices can be used to store program instructions for execution by processor(s) of control and memory circuit 118, for example. The storage devices, for example, are used by software, applications, algorithms, as examples, running on and/or executed by control and memory circuit 118. The storage devices can include short-term and/or long-term memory and can be volatile and/or non-volatile. Examples of non-volatile storage elements include magnetic hard discs, optical discs, floppy discs, flash memories, or forms of electrically programmable memories (EPROM) or electrically erasable and programmable (EEPROM) memories. Examples of volatile memories include random access memories (RAM), dynamic random-access memories (DRAM), static random-access memories (SRAM), and other forms of volatile memories known in the art.

While illustrated as positioned on the compactor 100, one or more control systems may be positioned remote from the compactors 100. For example, a remote computing system may be used by an operator to control the compactor 100 for a fully autonomous machine. In this example, the control and memory circuit 118 may communicate data to the remote computing device, or the lidar assemblies 112a and 112b and the ultrasonic sensors 116a and 116b may directly transmit data to the remote computing system.

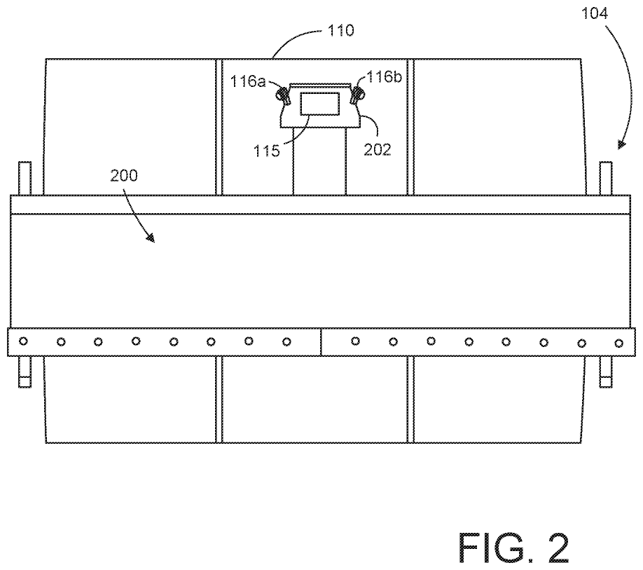

FIG. 2 is a front view of the second frame 104 of the compactor 100 that includes the ultrasonic sensors 116a and 116b mounted to an attachment 202 attached to the second frame 104. The blade 200. may be a dozer blade, for example, attached to the frame 104 and configured to push material in front of the compactor drum 110. The blade 200 may be positioned on the forward-most portion of the frame 104. The ultrasonic sensors 116a and 116b are mounted to an attachment 202 that is mounted to second frame 104. While illustrated as mounted to the second frame 104 using a common attachment 202 with the radar sensor 115, the ultrasonic sensors 116a and 116b may be attached to the second frame 104 using any method of mounting or attachment.

The ultrasonic sensor 116a is positioned on the left side of the attachment 202, and oriented to sense data in the area 114a during left turning of the compactor 100. The ultrasonic sensor 116b is positioned on the right side of the attachment 202, and oriented to sense data during right turning of the compactor 100. In some examples, the ultrasonic sensors 116a and 116b may mounted or otherwise attached at any position on the second frame 104. In an example, the ultrasonic sensors 116a and 116b may be mounted on separate attachments, for example, as close to the edges of the second frame 104 as possible to increase coverage during steering of the compactor 100,

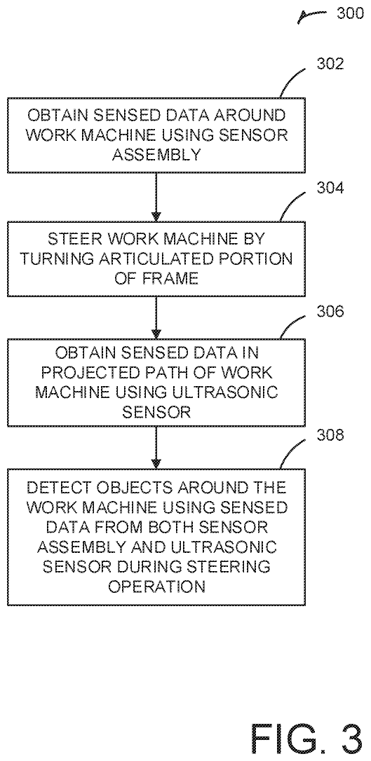

FIG. 3 is a flowchart illustrating a method 300 for providing obstacle detection using the ultrasonic sensors 116a and 116b. At step 302, an articulated-type soil compactor that includes a dozer blade, such as the compactor 100, is traveling in a straight path such that the frame 102 is substantially in-line with respect to the frame 104. Lidar assemblies 112a and 112b, positioned on the frame 102, may be used to obtain data indicative of obstacles behind, in front of, and to the sides of the soil compactor. In an example, the lidar assemblies may be attached to a top surface of the frame 102 and able to sense data to detect obstacles within several feet of the compactor in each direction of the compactor when the compactor is travelling in a substantially straight direction. In another example, a radar sensor assembly, such as the radar sensor 115, may be used in addition to, or in place of, the lidar assemblies 112a and 112b to sense data indicative of obstacles in front of the compactor 100.

At step 304. a steering operation begins for the compactor 100. To accomplish the steering operation, the frame 104 articulates with respect to the frame 102 to turn the compactor 100. Because of the articulation of the compactor 100, the lidar assemblies 112a and 112b on the frame 102 do not sense data within the projected path of the compactor 100. At step 306, to sense data within the projected path, ultrasonic sensors 116a and 116b are employed. The ultrasonic sensors 116a and 116b may be positioned on an attachment that is attached to the frame 104 forward of the compactor drum 110. For example, the ultrasonic sensor 116a may be used to sense data during a left tum of the compactor 100, and the ultrasonic sensor 116b may be used to sense data during a right turn of the compactor 100. At step 308, during turning of the compactor 100, obstacles are detected using both the lidar assemblies 112a and 112b and the respective ultrasonic sensor. Obstacles in the projected path may be detected using the ultrasonic sensors 116a and 116b, and obstacles to the sides and rear of the compactor may be detected using the lidar assemblies 112a and 112b,

### INDUSTRIAL APPLICABILITY

In one illustrative example, the work machine is an articulated-type automated soil compactor that includes a dozer blade, The automated soil compactor includes an obstacle detection system configured to detect obstacles around the soil compactor during operation of the soil compactor. The obstacle detection system may include at least two lidar assemblies and two ultrasonic sensors. The lidar assemblies are positioned on a first frame portion of the soil compactor and configured to sense data for detection of obstacles around the soil compactor. When a second portion of the frame turns with respect to the first portion to steer the soil compactor, the lidar assemblies sense insufficient data in the projected path of the compactor.

To sense data in the projected path, the ultrasonic sensors are used. One ultrasonic sensor is positioned on the second portion of the frame to sense data for detection of obstacles during a left tum of the compactor, and one ultrasonic sensor is positioned on the second portion of the frame to sense data for detection of obstacles during a right turn of the compactor. By using ultrasonic sensors, obstacle detection coverage during steering of the soil compactor can be accomplished without the need for additional lidar assemblies. Ultrasonic sensors are significantly cheaper than lidar assemblies and thus, by using ultrasonic sensors for steering coverage, the overall cost of the obstacle detection system is greatly reduced.

The above detailed description is intended to be illustrative, and not restrictive. The scope of the disclosure should, therefore, be determined with references to the appended claims, along with the full scope of equivalents to which such claims are entitled.

What is claimed is:

1. A work machine comprising:
a frame comprising:
a first portion; and
a second portion configured to pivot with respect to the first portion for steering the work machine;
a blade attached to the second portion of the frame;
a first sensor assembly positioned on the work machine and configured to sense data for detection of obstacles within a first area around the work machine; and.
an ultrasonic sensor attached to the second portion of the frame and configured to sense data for detection of obstacles within a second area around the work machine, the second area outside the first area when the second portion is in an articulated position with respect to the first portion.

2. The work machine of claim 1, wherein the first sensor assembly is a first lidar sensor assembly positioned on the first portion of the frame, and wherein the ultrasonic sensor is a first ultrasonic sensor, and wherein the articulated position is a first articulated position, and wherein the work machine further comprises a second lidar sensor assembly positioned on the first portion of the frame and configured to sense data for detection of obstacles within a third area around the work machine.

3. The work machine of claim 2, further comprising a second ultrasonic sensor attached to the second portion of the frame and configured to sense data for detection of obstacles within a fourth area around the work machine, the fourth area outside the third area when the second portion is in a second articulated position with respect to the first portion.

4. The work machine of claim 3, wherein the first articulated position is a position such that the second portion is turned to the left with respect to the first portion to steer the work machine to the left, and wherein the second articulated position is a position such that the second portion is turned to the right with respect to the first portion to steer the work machine to the right.

5. The work machine of claim 3, wherein the first and the second ultrasonic sensors are each positioned on a common attachment mounted to the second portion of the frame.

6. The work machine of claim I, wherein the first sensor assembly is a radar sensor assembly attached the second portion of the frame and configured to sense data to detect obstacles in an area forward of the blade.

7. The work machine of claim 1, wherein the work machine is a soil compactor, and wherein the second frame portion is configured to support a compactor drum.

8. A method for detecting obstacles during operation of a work machine, the method comprising:
sensing, using a first sensor assembly positioned on the work machine, data for detection of obstacles within a first area around the work machine;
steering the work machine in a first direction by pivoting a second portion of a frame of the work machine with respect to a first portion of the frame of the work machine, wherein a blade is attached to the second portion of the frame; and
sensing, using an ultrasonic sensor attached to the second portion of the frame, data for detection of obstacles within a second area around the work machine, the second area outside the first area when the second portion is in an articulated position with respect to the first portion.

9. The method of claim 8, wherein the first sensor assembly is a first lidar sensor assembly positioned on the first portion of the frame, and wherein the ultrasonic sensor is a first ultrasonic sensor, and wherein the articulated position is a first articulated position, and wherein the method further comprises:
sensing, using a second lidar sensor assembly positioned on the first portion of the frame, data for detection of obstacles within a third area around the work machine.

10. The method of claim 9, further comprising:
steering the work machine in a second direction opposite the first direction by pivoting the second portion of the frame with respect to the first portion; and
sensing, using a second ultrasonic attached to the second portion of the frame, data for detection of obstacles within a fourth area around the work machine, the fourth area outside the third area when the second portion is in a second articulated position with respect to the first portion.

11. The method of claim 10, wherein the first and the second ultrasonic sensors are positioned on a common attachment mounted to the second portion of the frame.

12. The method of claim 8, wherein the first sensor assembly is a radar sensor assembly positioned on the second portion of the frame.

13. The method of claim 12, wherein the radar sensor assembly is positioned on a common attachment with the ultrasonic sensor.

14. The method of claim 8, wherein the work machine is a soil compactor, and wherein the second frame portion is configured to support a compaction drum.

15. A compactor comprising:
a first frame portion;
a second frame portion configured to articulate with respect to the first frame portion for steering the compactor;
a blade attached to the second frame portion;
a sensor assembly positioned on the first frame portion or the second frame portion and configured to sense data for detection of obstacles within a first area around the compactor; and
an ultrasonic sensor attached to the second frame portion and configured to sense data for detection of obstacles within a second area around the compactor, the second area outside the first area when the second frame portion is in an articulated position with respect to the first frame portion.

16. The compactor of claim 15, wherein the ultrasonic sensor is a first ultrasonic sensor, and wherein the articulated position is a first articulated position, and wherein the sensor assembly is a first lidar sensor assembly positioned on the first frame portion, and wherein the compactor further comprises a second lidar sensor assembly positioned on the first frame portion and configured to sense data for detection of obstacles within a third area around the compactor.

17. The compactor of claim 16, further comprising a second ultrasonic sensor attached to the second frame portion and configured to sense data for detection of obstacles within a fourth area around the compactor, the fourth area outside the third area when the second frame portion is in a second articulated position with respect to the first frame portion.

18. The compactor of claim 17, wherein the first articulated position is a position such that the second frame portion is turned to the left with respect to the first frame portion to steer the compactor to the left, and wherein the second articulated position is a position such that the second frame portion is turned to the right with respect to the first frame portion to steer the compactor to the right.

19. The compactor of claim 17, wherein the first and the second ultrasonic sensors are positioned on a common attachment mounted to the second frame portion.

20. The compactor of claim 15, wherein the sensor assembly is a radar sensor assembly positioned on a common attachment with the ultrasonic sensor and configured to sense data to detect obstacles in an area forward of the blade.
